(19) United States
(12) Patent Application Publication
(10) Pub. No.: US 2025/0199699 A1
(43) Pub. Date: Jun. 19, 2025

(54) MEMORY DEVICE PERFORMING IN-MEMORY COMPUTING

(71) Applicant: SEOUL NATIONAL UNIVERSITY R&DB FOUNDATION, Seoul (KR)

(72) Inventors: Jae-Joon KIM, Seoul (KR); Munhyeon KIM, Seoul (KR); Eunhwan KIM, Pohang-si (KR)

(21) Appl. No.: 18/976,456

(22) Filed: Dec. 11, 2024

(30) Foreign Application Priority Data
Dec. 14, 2023 (KR) 10-2023-0181318
Apr. 5, 2024 (KR) 10-2024-0046447

(51) Int. Cl. G06F 3/06

(52) U.S. Cl. CPC G06F 3/0625; G06F 3/0629; G06F 3/0673

(57) ABSTRACT

A memory device including at least one memory cell includes a nonvolatile memory cell; a first switching element having one terminal connected to the nonvolatile memory cell and being switched according to input data; an inverter connected to a multiplication node to which the nonvolatile memory cell and the first switching element are connected; and a capacitor connected to an output node of the inverter, herein the memory cell performs in-memory computing, and the capacitor outputs a computational operation result between storage data stored in the nonvolatile memory cell and the input data.

### CROSS-REFERENCE TO RELATED APPLICATION

This application claims the benefit under 35 USC 119(a) of Korean Patent Application Nos. 10-2024-0046447 filed on Apr. 5, 2024 and 10-2023-0181318 filed on Dec. 14, 2023 in the Korean Intellectual Property Office, the entire disclosures of which are incorporated herein by reference for all purposes.

### BACKGROUND

### 1. Field

The present disclosure relates to a memory device that performs in-memory computing.

### 2. Description of the Related Art

A conventional memory device may be divided into static random access memory (SRAM) used as cache memory and dynamic random access memory (DRAM) used as main memory. Because SRAM is used for a high-speed operation and is composed of six transistors in usual, the SRAM has a low integration, and accordingly, there is a problem that an area increases when implementing high-capacity memory.

In contrast to this, because DRAM is composed of a one transistor one capacitor (1T1C) cell structure in usual, the DRAM may be implemented in high capacity and high integration, but an operation speed is slow compared to SRAM and data retention time is short, and accordingly, there is a problem that a refresh is required at a certain period even during hold time, not during a read/write operation.

Meanwhile, embedded non-volatile memory (eNVM) is being actively studied as an alternative to SRAM and DRAM and has an advantage in that refresh is not require as a non- volatile memory and integration is high. However, because eNVM generally has a limited on/off ratio, an in-memory computing operation that requires a parallel computation results in a loss of output information compared to the amount of input information. The in-memory computing is also called computing in memory or processing in memory, and is a technology that allows memory to perform a computational function in addition to a data storage function, and has recently been widely studied as a technology for implementing AI semiconductors.

The present disclosure provides a memory device based on non-volatile memory cells that may be applied to in-memory computing.

A related patent document includes US patent publication No. 2023-0259748 (Title: In-memory computing architecture and methods for performing mac operations).

### SUMMARY

In order to solve the problems described above, the present disclosure provides a memory device that may perform in-memory computing based on nonvolatile memory cells.

However, technical problems to be achieved by the present embodiment are not limited to the technical problems described above, and there may be other technical problems. According to an aspect of the present disclosure, a memory device including at least one

memory cell includes a nonvolatile memory cell; a first switching element having one terminal connected to the nonvolatile memory cell and being switched according to input data; an inverter connected to a multiplication node to which the nonvolatile memory cell and the first switching element are connected; and a capacitor connected to an output node of the inverter, herein the memory cell performs in-memory computing, and the capacitor outputs a computational operation result between storage data stored in the nonvolatile memory cell and the input data.

According to the present disclosure, an in-memory computing memory cell having a simple structure may be implemented based on a nonvolatile memory cell. In particular, by using capacitor-based coupling, energy efficiency may be improved, and an area may be reduced.

### BRIEF DESCRIPTION OF THE DRAWINGS

FIG. 1 illustrates a memory device according to an embodiment of the present disclosure.

FIG. 2 is a diagram illustrating a configuration of a memory cell included in the memory device.

FIG. 3 is a truth table showing a computational result of the memory cell according to the present disclosure.

FIG. 4 is a diagram showing an operating principle of the memory cell according to the present disclosure.

FIG. 5 illustrates an example of a layout of a memory cell array using the memory cell, according to the present disclosure.

### DETAILED DESCRIPTION

Hereinafter, embodiments of the present disclosure will be described in detail with reference to the attached drawings such that those skilled in the art to which the present disclosure belongs may easily practice the present disclosure. However, the present disclosure may be implemented in various different forms and is not limited to the embodiments described herein. In addition, in order to clearly describe the present disclosure in the drawings, parts that are not related to the description are omitted, and similar components are given similar reference numerals throughout the specification.

In the entire specification of the present disclosure, when a component is described to be “connected” to another component, this includes not only a case where the component is “directly connected” to another component but also a case where the component is “electrically connected” to another component with another element therebetween. In addition, when it is described that a portion “includes” a certain component, this means that the portion may further include another component without excluding another component unless otherwise stated.

In the present disclosure, a “portion” includes a unit realized by hardware, a unit realized by software, and a unit realized by using both. In addition, one unit may be realized by using two or more pieces of hardware, and two or more units may be realized by using one piece of hardware. Meanwhile, a “˜portion” is not limited to software or hardware, and a “˜portion” may be configured to be included in an addressable storage medium or may be configured to reproduce one or more processors. Therefore, in one example, “˜portion” refers to components, such as software components, object-oriented software components, class components, and task components, and includes processes, functions, properties, and procedures, subroutines, segments of program code, drivers, firmware, microcode, circuits, data, databases, data structures, tables, arrays, and variables. The functions provided within the components and “portions” may be combined into a smaller number of components and “portions” or may be further separated into additional components and “portions”. Additionally, components and “portions” may be implemented to regenerate one or more central processing units (CPUs) included in a device or security multimedia card.

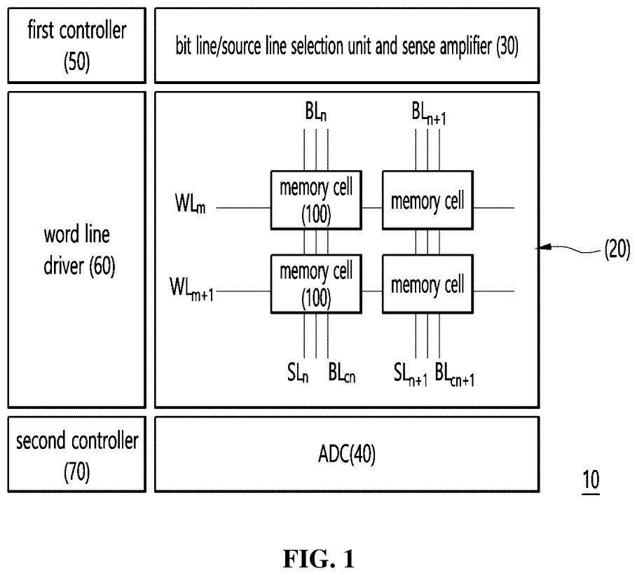

FIG. 1 illustrates a memory device according to an embodiment of the present disclosure.

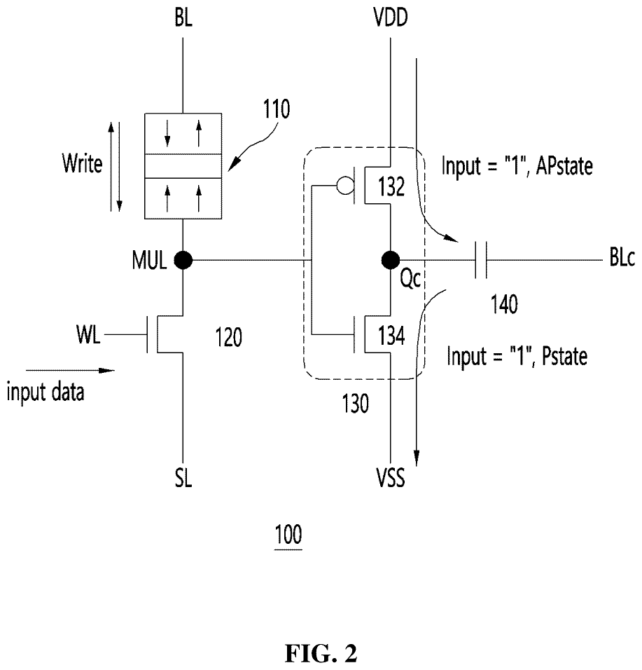

A memory device 10 includes a memory cell array 20 including one or more memory cells 100 arranged in an array form, and various peripheral circuits. The various peripheral circuits may include a bit line/source line selection unit and sense amplifier 30 that switches bit lines or source lines connected to the one or more memory cells 100, an analog-to-digital converter (ADC) 40 that converts an analog signal output from the memory cell array 20 into a digital signal, a first controller 50, a word line driver 60, and a second controller 70. The first controller 50 controls an operation of a nonvolatile memory cell 110 (see FIG. 2) included in the memory cell 100, and the second controller 70 controls an operation of the memory cell 100.

FIG. 2 illustrates a configuration of the memory cell 100 according to an embodiment of the present disclosure.

The memory cell 100 includes the nonvolatile memory cell 110, a first switching element 120 that has one terminal connected to the nonvolatile memory cell 110 and is switched according to input data, an inverter 130 connected to a multiplication node MUL to which the nonvolatile memory cell 110 and the first switching element 120 are connected, and a capacitor 140 connected to an output node of the inverter 130.

More specifically, the nonvolatile memory cell 110 has one terminal connected to a bit line BL and the other terminal connected to the multiplication node MUL. In addition, the first switching element 120 has a gate connected to a word line WL to which input data is applied and has the other terminal connected to a source line SL. The inverter 130 includes a second switching element 132 and a third switching element 134 which are switched according to a signal of the multiplication node MUL.

As illustrated in FIG. 2, the memory cell 100 includes the nonvolatile memory cell 110 and the first switching element 120 which are connected in series between a bit line BL and the source line SL, and a connection node of the nonvolatile memory cell 110 and the first switching element 120 functions as the multiplication node MUL. In this case, the nonvolatile memory cell 110 may include magnetic random access memory (MRAM) and may also include resistance RAM (ReRAM), phase-change RAM (PRAM), resistive RAM (RRAM), ferroelectric RAM (FRAM), and so on. In this way, the present disclosure may configure the memory cell 110 based on a one transistor one resistor (1T1R) structure.

When the nonvolatile memory cell 110 is a magnetoresistive memory, a state thereof is divided into a high resistance state (HRS) and a low resistance state (LRS) according to the information recorded in the nonvolatile memory cell 110. In addition, during a read operation, when a current flowing through the nonvolatile memory cell 110 is low, the state of the nonvolatile memory cell 110 may be read as HRS (AP, data 0), and when the current is high, the state of the nonvolatile memory cell 110 may be read as LRS (P, data 1). In addition, during a write operation, a set voltage Vset that changes HRS to LRS or a reset voltage Vreset that changes LRS to HRS may be applied to change a state of a resistor.

In addition, the inverter 130 may be implemented as a CMOS inverter including the second switching element 132 based on a PMOS and the third switching element 134 based on an NMOS. The inverter 130 may amplify a voltage of the multiplication node MUL. Accordingly, a difference in an output state of the multiplication node MUL may be further amplified. However, in order to do this smoothly, a voltage VTRIP of the inverter 130 has to be located between a high level output VHRS and a low level output VLRS of the multiplication node MUL, and a voltage margin that is sufficiently robust to PVT is required. The inverter 130 amplifies a voltage of the multiplication node MUL and inverts the amplified voltage to be output, and a voltage of an output node Qc of the inverter 130 is used as a voltage for computing. When the inverter 130 is used as an amplifier, a gain is generally 4 or more, and accordingly, when the nonvolatile memory cell 110 with a limited LRS/HRS ratio is used in computing mode, a dynamic range may be amplified by the gain of the inverter 130.

The capacitor 140 is connected to the output node Qc of the inverter 130 and outputs a computational result of the memory cell 100 through a capacitive coupling operation. Because the capacitor 140 outputs charge-based computation, the capacitor 140 has an advantage of high energy efficiency compared to other element-based computations. One terminal of the capacitor 140 is connected to the output node Qc of the inverter 130, and an in-memory computational result is transferred to the other terminal BLc of the capacitor 140 through capacitive coupling. A voltage of the output node Qc of the inverter 130 increases (develops), and when the increase of the output node Qc is completed in a state where the other terminal BLc is precharged to a power supply voltage Vdd, the other terminal BLc is floated such that the voltage of the output node Qc is applied to the other terminal BLc.

First, data write and read operations of the memory cell 100 are described below. During a write operation, a high-level voltage is applied to the word line to turn on the first switching element 120, voltages are respectively applied to the bit line BL and the source line SL to record data in the nonvolatile memory cell 110. For example, in order to change a state of resistance of the nonvolatile memory cell 110, the set voltage Vset that changes HRS to LRS or the reset voltage Vreset that changes LRS to HRS may be applied.

In addition, during a read operation, the same process as the write operation is repeated with a lower voltage compared to the write voltage. When a current flowing through the nonvolatile memory cell 110 is low, a state of the nonvolatile memory cell 110 may be read as HRS (data 0), and when the current is high, the state of the nonvolatile memory cell 110 may be read as LRS (data 1).

Meanwhile, storage data stored in the nonvolatile memory cell 110 may be weight data that constitutes an artificial intelligence model or a deep neural network model for which learning is completed.

Next, a computational operation performed by in the memory cell 100 is described.

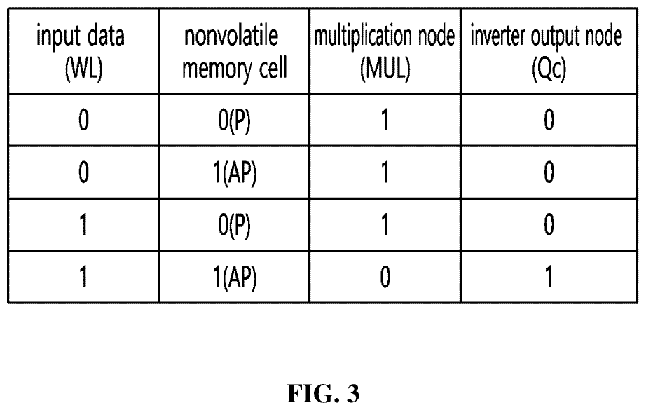

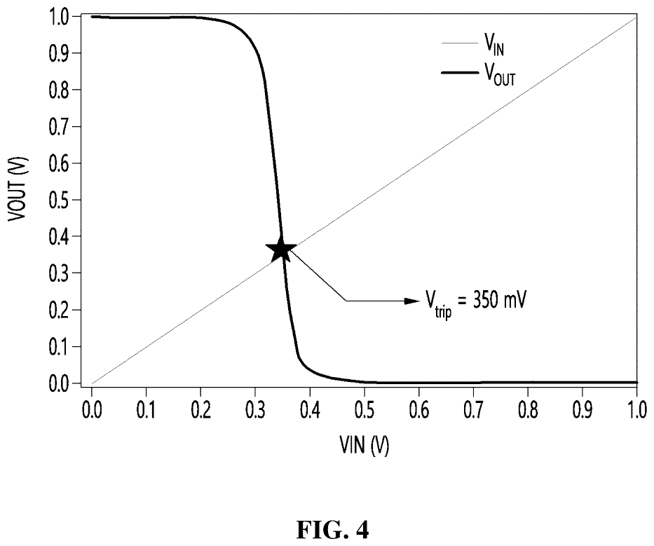

FIG. 3 is a truth table showing a computational result of the memory cell 100 according to the present disclosure, and FIG. 4 is a diagram illustrating an operating principle of the memory cell 100 according to the present disclosure.

When a computational operation is performed by the memory cell 100, input data is applied through the word line WL. The input data may be input activation data of each layer constituting a deep neural network or so on, and multiplication of the input data and storage data may correspond to multiplication of an input activation and weight data.

When the input data is 0, the first switching element 120 is turned off, and the multiplication node MUL constantly maintains a high level regardless of a state of the nonvolatile memory cell 110 because a voltage of the multiplication node MUL is equal to a voltage of the bit line BL. Accordingly, the inverter 130 outputs data of a low level. In addition, the output node Qc of the inverter 130 maintains a low level state.

In contrast to this, when the input data is 1, an output of the multiplication node MUL is determined according to a state of the nonvolatile memory cell 110. As described above, when a resistance state of the nonvolatile memory cell 110 is LRS (P), that is, when low level data is stored in the nonvolatile memory cell 110, a voltage of the multiplication node MUL is measured as a high voltage, and accordingly, the inverter 130 outputs low level data. That is, the third switching element 134 is turned on, and accordingly, the capacitor 140 connected to the output node Qc is discharged.

In addition, when the resistance state of the nonvolatile memory cell 110 is HRS (AP), that is, when high level data is stored in the nonvolatile memory cell 110, a voltage of the multiplication node MUL is measured as a low voltage, and accordingly, the inverter 130 outputs high level data. That is, the second switching element 132 is turned on, and the capacitor 140 connected to the output node Qc is charged to a high level.

As a result, it can be seen that the memory cell 100 may perform a NAND operation on the input data and the storage data stored in the nonvolatile memory cell 110.

Meanwhile, FIG. 4 is a transfer function showing characteristics of the inverter 130, and when a trip voltage is, for example, 350 mV, a voltage of the multiplication node MUL increases or decreases based thereon.

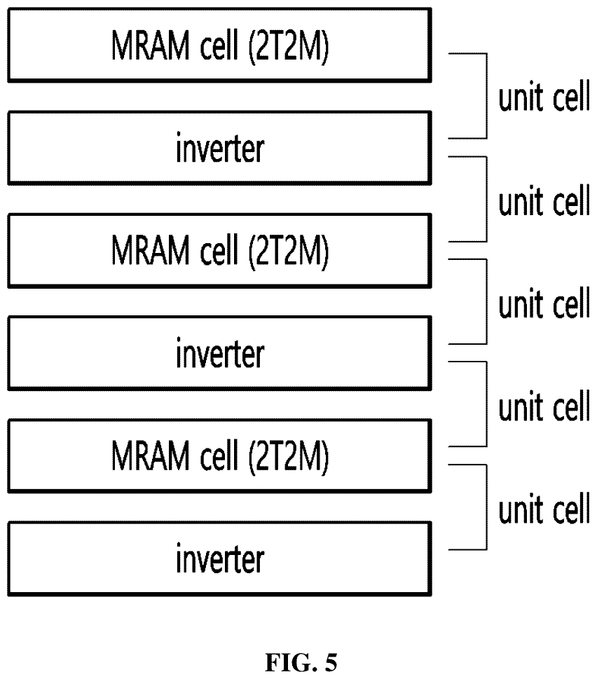

FIG. 5 illustrates an example of a layout of a memory cell array using memory cells, according to the present disclosure.

For example, when MRAM is used as a nonvolatile memory cell, area efficiency of the memory cell array 20 may be improved by using a method of alternately arranging the MRAM and the inverter 130.

A method according to an embodiment of the present disclosure may be performed in the form of a recording medium including instructions executable by a computer, such as a program module executed by a computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

In addition, although the method and system of the present disclosure are described with respect to specific embodiments, some or all of components or operations thereof may be implemented by using a computer system having a general-purpose hardware architecture.

The above description of the present disclosure is intended to be illustrative, and those skilled in the art will appreciate that the present disclosure may be readily modified in other specific forms without changing the technical idea or essential characteristics of the present disclosure. Therefore, the embodiments described above should be understood as illustrative in all respects and not limiting. For example, each component described in a single type may be implemented in a distributed manner, and likewise, components described in a distributed manner may be implemented in a combined form.

The scope of the present application is indicated by the claims described below rather than the detailed description above, and all changes or modified forms derived from the meaning, scope of the claims, and their equivalent concepts should be interpreted as being included in the scope of the present application.

What is claimed is:

1. A memory device including at least one memory cell, the memory device comprising:
a nonvolatile memory cell;
a first switching element having one terminal connected to the nonvolatile memory cell and being switched according to input data;
an inverter connected to a multiplication node to which the nonvolatile memory cell and the first switching element are connected; and
a capacitor connected to an output node of the inverter,
wherein the memory cell performs in-memory computing, and
the capacitor outputs a computational operation result between storage data stored in the nonvolatile memory cell and the input data.

2. The memory device of claim 1, wherein
the nonvolatile memory cell has a first terminal connected to a bit line and has a second terminal connected to the multiplication node,
the first switching element has a gate connected to a word line to which the input data is applied and has another terminal connected to a source line, and
the inverter includes a second switching element and a third switching element, each of which is switched according to a signal of the multiplication node.

3. The memory device of claim 1, wherein
during a data write operation or a data read operation for the nonvolatile memory cell, the data write operation or the data read operation is performed for the nonvolatile memory cell in a state where the first switching element is turned on.

4. The memory device of claim 1, wherein
when the memory cell performs a computational operation, a NAND operation result of the storage data and the input data is output from the memory cell.

5. The memory device of claim 1, wherein
while the memory cell performs a computational operation,
when the input data is 0, an output of the multiplication node is constantly in a high level state regardless of a state of the nonvolatile memory cell, and the inverter outputs low level data, and
when the input data is 1, the output of the multiplication node is in a low level state or a high level state according to the state of the nonvolatile memory cell, and the inverter outputs one of high level data and low level data.

6. The memory device of claim 5, wherein
in a case where the input data is 1, when the low level data is stored in the nonvolatile memory, the output of the multiplication node is high level, and the inverter outputs the low level data, and
in a case where the input data is 1, when the high level data is stored in the nonvolatile memory, the output of the multiplication node is low level, and the inverter outputs the high level data.

7. The memory device of claim 1, wherein
the nonvolatile memory cell is magnetic random access memory (MRAM).
